(19) United States
(12) Patent Application Publication
(10) Pub. No.: US 2003/0163387 A1
(43) Pub. Date: Aug. 28, 2003

(54) Method for marketing paper making machinery

(76) Inventors: Edward R. Ryan, Huron, OH (US); Paul J. Daugherty, Sandusky, OH (US); John C. Rogers, Sandusky, OH (US)

Correspondence Address: EMCH, SCHAFFER, SCHAUB & PORCELLO CO, P O BOX 916, ONE SEAGATE SUITE 1980, TOLEDO, OH, 43697

(21) Appl. No.: 10/369,422

(22) Filed: Feb. 18, 2003

Related U.S. Application Data
(60) Provisional application No. 60/358,858, filed on Feb. 22, 2002.

(51) Int. Cl. G06F 17/60

(52) U.S. Cl. 705/26

(57) ABSTRACT

The present invention is a method for marketing paper making machinery. The steps of the method are as follows: presenting paper making machinery comprised of a metal alloy to a customer with an extended warranty for a time period of more than ten years; receiving information from a customer about the machinery; analyzing the information; designing the machinery; pricing the machinery; offering the machinery to the customer with the terms and conditions of the extended warranty for the machinery; receiving acceptance of the offer from the customer; manufacturing the machinery; shipping the machinery to the customer for installation and use; and monitoring the customer's use of the machinery pursuant to the terms of the extended warranty.

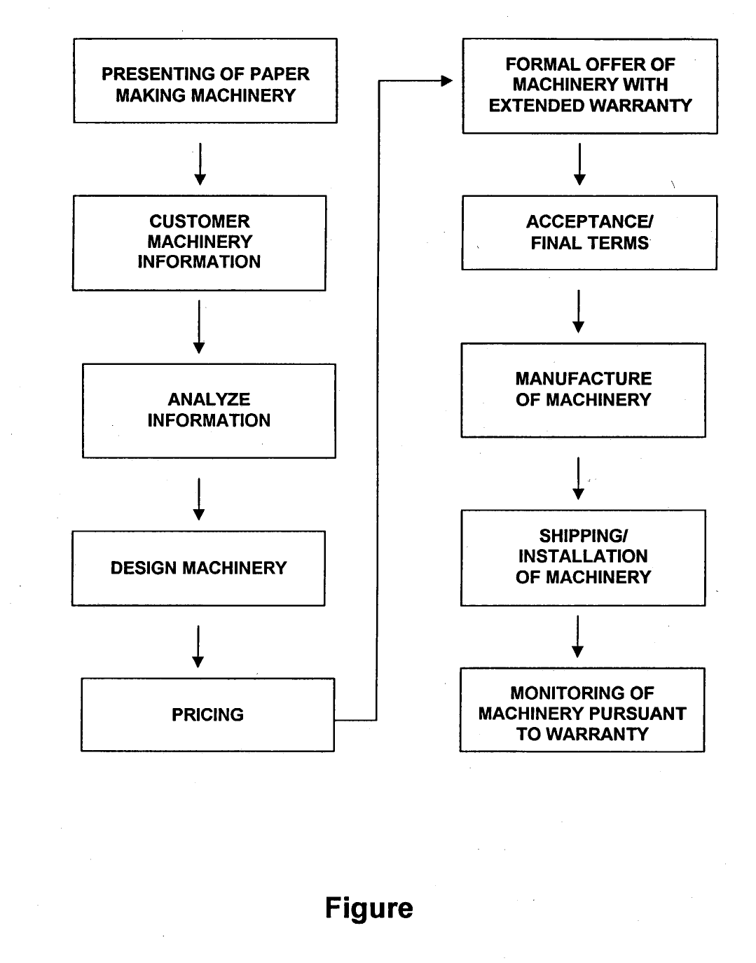

### RELATED APPLICATION

The present application relates to and claims the benefit of U.S. Provisional Patent Application No. 60/358,858, filed on Feb. 22, 2002.

### BACKGROUND OF THE INVENTION

The present invention is generally directed to a method for marketing machinery. More specifically, the invention is directed to a method of marketing paper making machinery.

Paper making machinery including paper machine rolls, suction rolls and roll shells have been marketed in a variety of ways. Paper making machinery is usually sold with a short warranty period of two to three years. In rare instances, warranties extend for up to ten years. The warranties usually include terms for a prorated decline in replacement value.

Short warranty periods are a problem in the industry. Customers who make large investments in paper making machinery want assurances from the manufacturer that the machinery will have a long, useful life.

The present invention solves the above-stated problem by providing a method for marketing paper making machinery including a warranty period that extends for more than ten years with full replacement value.

### SUMMARY OF THE INVENTION

The present invention is a method for marketing paper making machinery. The steps of the method are as follows: presenting paper making machinery comprised of a metal alloy to a customer with an extended warranty for a time period of more than ten years; receiving information from a customer about paper making machinery; analyzing the information about the machinery; designing the machinery; pricing the machinery; offering the machinery to the customer with the terms and conditions of the extended warranty for the machinery; receiving acceptance of the offer from the customer; manufacturing the machinery; shipping the machinery to the customer for installation and use; and monitoring the customer's use of the machinery pursuant to the terms and conditions of the extended warranty.

The primary object of the present invention is to provide a method for marketing paper making machinery.

Other objects and advantages of the present invention will become apparent to those skilled in the art upon a review of the following detailed description of the preferred embodiments and the accompanying drawings.

### BRIEF DESCRIPTION OF THE DRAWINGS

The Figure is a flow diagram showing the method steps of the present invention.

### DETAILED DESCRIPTION OF THE PREFERRED EMBODIMENTS

The preferred embodiments and best mode of the present invention will now be described in detail with reference being make to the drawings. The present invention is directed to a method for marketing paper making machinery.

The present invention utilizes paper making machinery including paper machine rolls, suction rolls, roll shells and related parts. These articles will hereinafter be referred to as machinery.

The machinery is comprised of a metal alloy depending on the use of the machinery. In a preferred embodiment, the machinery is comprised of one of the copper-bearing duplex stainless steel alloys disclosed in U.S. Pat. Nos. 4,612,069 and 4,740,254, the teachings of which are incorporated herein by reference.

In the present method, as shown in the Figure, machinery comprised of a specific alloy is presented by a machinery manufacturer to a customer such as a paper mill. The machinery is presented with an extended warranty having a time period of more than ten years from the date of shipment of the machinery from the manufacturer to the customer with full replacement value if the machinery fails within the time period. Accordingly, no prorated declining value is used. In a preferred embodiment, the warranty period is twenty years from the date of shipment of the machinery. The warranty period can also be a “lifetime” warranty, which extends for the anticipated useful life of the machinery as determined by the manufacturer. The warranty period of the present invention will hereinafter be referred to as “extended warranty”.

The machinery manufacturer receives a request from a customer for machinery. The manufacturer receives information from the customer concerning the intended use for the machinery.

The customer information is then analyzed by the manufacturer. After analysis is complete, the manufacturer designs machinery for the customer. During this process, the manufacturer prepares drawings of the machinery. The drawings are sent to the customer for review and approval. This is done by computer interface or manually.

After approval of the design, the manufacturer performs pricing analysis. This step is performed by computer interface or manually.

After the pricing phase is complete, the manufacturer prepares and sends a formal offer to the customer. The formal offer includes the design information and the pricing information for the machinery. The formal offer also includes the terms and conditions of the extended warranty.

The extended warranty is based on the design criteria for the machinery. The extended warranty includes provisions concerning the continuing review and analysis of the customer's use of the machinery by the manufacturer to validate the design criteria of the machinery. Under the terms of the extended warranty, operational and process changes made by the customer will be communicated to the manufacturer in order to support the extended warranty.

The extended warranty is based on one or more design criteria of the machinery, including the number of cycles of the machinery (e.g., 10⁹ cycles); the number of years of anticipated usage of the machinery (e.g., twenty years); the wall thickness of the machinery; new applications for the machinery that might exceed the original design criteria for the machinery; maximum operating stress of the machinery; maximum deflecting of the machinery; and exposure of the machinery to various corrosive environments.

In an alternative embodiment, the extended warranty of the present invention includes provisions for insurance against failure of the machinery during intended use. The insurance provisions are provided to the customer at the time when the machinery is first offered to the customer or at the time of the formal offer to the customer.

Once the terms of the formal offer are finalized, the customer sends an acceptance of the formal offer to the manufacturer. This can be done in a written confirmation, such as a letter, or in a purchase order. The manufacturer acknowledges the acceptance and provides the final terms and conditions for the sale.

The manufacturer develops a production print of the machinery. The print can be based on information received from the customer or through the preparation of an original print by the manufacturer.

The production print is used to manufacture the machinery. The machinery is labeled or identified with operational limits for retrieval ease. For example, loading limits, wall thickness minimums, speed ratings, and temperature limits can be identified.

The manufactured machinery is shipped to the customer with complete documentation concerning the machinery. The documentation includes the extended warranty terms and conditions as described above. The documentation also includes details concerning use of the machinery by the customer. After shipping, the machinery is installed and used by the customer.

During the time period of the extended warranty, the customer provides continuing, post-sale information to the manufacturer concerning use of the machinery. This information includes the present condition of the machinery and any proposed changes for use of the machinery. Under the terms of the extended warranty, the customer is obligated to inform the manufacturer of any changes of use for analysis and approval by the manufacturer.

In the present method, the manufacturer will replace the machinery at full replacement value if it fails during its original intended use pursuant to the terms and conditions of the extended warranty. The machinery will also be replaced at full replacement value if it fails after any changes in the usage of the machinery that have been approved by the manufacturer pursuant to the terms of the extended warranty.

The method of the present invention provides a new and useful method for marketing paper making machinery. The method provides an extended warranty for more than ten years with full replacement value that has not been utilized previously in the paper making machinery industry. The full replacement value terms allow for superior customer claim resolution. The method provides the manufacturer with an advantage because customers of rolls will be assured of a long, useful life of machinery purchased from the manufacturer. This will cause an increase in sales for the manufacturer. Further, the present method provides for the post-sale monitoring of the machinery to validate the design as operational parameters change.

The above detailed description of the present invention is given for explanatory purposes. It will be apparent to those skilled in the art that numerous changes and modifications can be made without departing from the scope of the invention. Accordingly, the whole of the foregoing description is to be construed in an illustrative and not a limitative sense, the scope of the invention being defined solely by the appended claims.

We claim:

1. A method comprising:
(a) presenting paper making machinery comprised of a metal alloy to a customer with an extended warranty for a time period of more than ten years from the date of shipment of the paper making machinery;
(b) receiving information from the customer about the paper making machinery;
(c) analyzing the information about the paper making machinery;
(d) designing the paper making machinery;
(e) pricing the paper making machinery;
(f) sending a formal offer for the paper making machinery to the customer with the terms of the extended warranty for the paper making machinery;
(g) receiving acceptance of the formal offer from the customer;
(h) manufacturing the paper making machinery;
(i) shipping the paper making machinery to the customer for installation and use; and
(j) monitoring the customer's use of the paper making machinery pursuant to the terms of the extended warranty.

2. The method of claim 1, wherein the paper making machinery is selected from the group consisting of paper machine rolls, suction rolls and roll shells.

3. The method of claim 1, wherein said metal alloy is a duplex stainless steel alloy.

4. The method of claim 1, wherein said extended warranty has a time period of at least twenty years.

5. The method of claim 1, wherein said extended warranty has a time period that extends for the anticipated useful life of the paper making machinery.

6. The method of claim 1, wherein the terms of the extended warranty are based on design criteria of the paper making machinery selected from the group consisting of number of cycles of the machinery, number of years of anticipated usage of the machinery, wall thickness of the machinery, new applications for the machinery, maximum operating stress of the machinery, maximum deflecting of the machinery, and exposure of the machinery to corrosive environments.

7. The method of claim 1, wherein the terms of the extended warranty include replacement of the machinery at full replacement value if the machinery fails during intended use.

8. The method of claim 1, wherein the terms of the extended warranty include insurance against failure of the machinery during intended use.
